(19) United States
(12) Patent Application Publication
(10) Pub. No.: US 2013/0099666 A1
(43) Pub. Date: Apr. 25, 2013

(54) SELECTIVELY CONTROLLING THE RESISTANCE OF RESISTIVE TRACES PRINTED ON A SUBSTRATE TO SUPPLY EQUAL CURRENT TO AN ARRAY OF LIGHT SOURCES

(71) Applicant: Kevin Stuffle, Tucson, AZ (US)

(72) Inventor: Kevin Stuffle, Tucson, AZ (US)

(73) Assignee: ALMAX RP CORP., Kirkland, WA (US)

(21) Appl. No.: 13/278,761

(22) Filed: Oct. 21, 2011

(51) Int. Cl. H01J 7/44

(52) U.S. Cl. 315/52

(57) ABSTRACT

A light emitting display includes a plurality of light emitting diodes (LEDs) or other type of light sources mounted in a parallel-connected array that is supplied electrical current from a power bus. A voltage drop occurs along the power bus, where each successive LED is connected. To achieve either substantially equal current flow (or different desired levels of current flow) through the LEDs, a conductance of resistive traces that connect the LEDs to the power bus is selectively controlled. The resistive traces are formed by printing a resistive ink on the substrate. The conductivity of the ink used to form the resistive traces, their length, and/or the width or other cross-sectional size of the resistive traces may be selectively controlled to achieve the desired electrical current supplied to each light source, so that a uniform or desired light intensity is emitted by the LEDs.

### BACKGROUND

There are a number of applications, such accent and decorative lighting, functional spot lighting and low intensity area lighting, and equipment displays and indicators, in which it is desirable to energize a plurality of light sources mounted on an elongate, longitudinally extending flexible substrate. The substrate may extend linearly, like a tape or may be contoured within a plane, for example, in the shape of alphanumeric characters. Also, the substrate may be bonded to a surface, free hanging, draped from a support, or wound around an object. While light emitting diodes (LEDs) are commonly used for the light sources on such displays, other types of light source, such as laser diodes, can also be used. The light sources may be mounted in a spaced-apart array that extends in a longitudinal direction, along an elongate flexible substrate or the substrate can be formed in other shapes, depending on the application and the purpose of the display.

When the light sources are arranged in parallel configuration, a power bus comprising a pair of conductive traces is typically used to supply electrical current to energize the light sources in the display. An electrical current from a power source is connected to the conductive traces, and each of the light sources are connected in parallel to the power bus and energized by the electrical current. A resistor is connected in series with each LED to limit the current. In some applications, it may be desirable to selectively energize different color light sources, using electrical current supplied through longitudinally extending conductors, so that a desired color pattern of light is produced by the display.

One of the problems associated with light emitting displays like those described above arises because the conductive traces used as the power bus to supply electrical current to the light sources are typically very thin and have a noticeable resistance. Also, if a conductive ink is used to form the conductive traces, the typical conductive ink applied to flexible substrates can have a relatively high resistivity, even though they typically include silver. Due to the resistivity of the conductive traces employed for an elongate flexible substrate display, the voltage supplied by the power bus to successive light sources decreases over the length of the substrate, and less electrical current flows through the light sources. Consequently, there is a noticeable decrease in the intensity of light produced by light sources disposed nearer the distal end of substrate, compared to the light sources that are mounted closer to the proximal end of the substrate.

In many applications for light displays, there are limitations on the width and thickness of the substrate and light sources mounted on it that preclude the use of discrete conventional resistors for the purpose of equalizing current supplied to the light sources. It is also desirable to produce light displays at a relatively low cost. Since silver is a precious resource, it is desirable to minimize the amount used for the conductive traces. This goal can be achieved for any given span and number of light sources when the width of the conductive traces approaches the minimum allowable to provide equal current in each light source, assuming that the cross sectional dimensions of the conductive traces are uniform along their length. Accordingly, there is a need for a compact and flexible configuration that can provide equal intensity light (or light of a desired intensity) from light sources that are mounted along an extending flexible substrate, by compensating for the reduced voltage occurring along a power bus supplying electrical current to the light sources.

### SUMMARY

Accordingly, a first aspect of the present novel approach is directed to an exemplary light emitting display that includes a substrate having a power bus with a first bus conductor and a second bus conductor that extend generally from an end that is connected to an electrical power source, such as a battery or a generally conventional alternating current (AC) line-powered direct current source. A plurality of light sources that emit light when energized by an electrical current are mounted on the substrate between the first bus conductor and the second bus conductor of the power bus.

A plurality of resistive traces extends between the power bus and the plurality of light sources. The resistance of the plurality of resistive traces is selectively controlled at least in part to compensate for a decreasing voltage along the power bus, so that each of the plurality of light sources is energized with a desired electrical current, regardless of a position along the power bus where each of the plurality of light sources is connected to the power bus, so that each of the plurality of light sources emit light of either substantially the same intensity or desired different intensities.

It is contemplated that in most applications, the light sources will comprise light emitting diodes (LEDs); however, the present approach is not in any way limited to LEDs and can be used with many other types of light sources that are suitable for surface mounting to a substrate, such as laser diodes, polymer light emitting diodes (PLEDs), and organic light emitting diodes (OLEDs), by way of example, and without any intended limitation.

A width of the resistive traces conveying electrical current between the power bus and the light sources can be adjusted for successive light sources mounted along the substrate, to compensate for the voltage drop along the power bus. The width of the resistive traces is generally increased to provide a greater conductivity that compensates for a decreasing voltage along the power bus, that occurs with increasing distance from the end connected to the power source.

Alternatively, a different cross-sectional size of the resistive traces, such as the thickness of the traces, can be adjusted for each of the successive light sources mounted along the substrate. The cross-sectional size of the resistive traces will generally be increased to compensate for a decreasing voltage along the power bus, as the distance from the connection to the power source increases. It is also possible to employ a strategy in which the conductive traces comprising the power bus are not parallel, but instead, are offset to become increasingly closer to the light sources along the length of the power bus. In this case, it is possible to use a constant width for the resistive traces, since the resistance of the resistive traces is directly proportional to their length. Further, it would be possible to employ a combination of the two techniques where both the width and length of the resistive traces are varied to achieve equal (or desired) current magnitudes flowing through each light source. There are some aesthetic and practical advantages in the conductors comprising the power bus being disposed at the edges of the substrate and the substrate being of a constant width like a tape, so that the constant length resistive traces may be preferred. However, it should be noted that the technique of varying the length of the resistive traces is equally applicable in achieving a desired electrical current flow through each of the light sources mounted on the substrate.

The resistive traces are sized to ensure that for the substrate being used, a predefined power loading per unit area of the resistive traces is not exceeded.

The light display may also include conductive traces that connect the power bus (on one side or on both sides) to some or all of the plurality of light sources. In some exemplary embodiments, the conductive traces and the first and second bus conductors are printed on the substrate using a conductive ink that includes silver.

In one or more exemplary embodiments, the resistive traces comprise a resistive ink that is applied to the substrate and cured. In at least some exemplary embodiments, the resistive ink includes carbon. Also, in at least some exemplary embodiments, the resistive ink is printed on the substrate using a positive displacement pen plotter, although it is contemplated that other printing processes, such as printing with an ink jet printer or screen printer might alternatively be used. A conductivity of the resistive ink can be varied to selectively control the resistance of the resistive traces. For example, by increasing the conductivity of the resistive ink used to form the resistive traces applied to the substrate, it is possible to compensate for a decreasing voltage along the power bus, with increasing distance from the end connected to the power source.

In at least one exemplary embodiment, both at least one of a width and a cross-sectional size of the resistive traces, as well as the conductivity of the conductive ink used to form the resistive traces are selectively varied to achieve the desired electrical current supplied to each of the light sources.

The substrate may comprise a thin flexible material that is readily bent without damage to the light emitting display, but the present approach is also applicable to more rigid substrates that are not intended to be bent or flexed. In at least some exemplary embodiments, the substrate is generally elongate in shape. A length of the substrate can approach a theoretical maximum, based on electrical parameters for the light emitting display, including the applied voltage, the forward voltage for each light source, and the desired electrical currents for each light source. Also, the plurality of light sources can comprise an array that extends between opposite ends of the power bus, regardless of the shape of the power bus. Thus, the array can define at least one curve. In some exemplary embodiments, the plurality of light sources can be disposed on the substrate to visually appear as one or more alphanumeric characters when the plurality of light sources are energized by an electrical current. Virtually any shape or design can similarly be represented by the light sources energized in accord with the present approach.

It is also contemplated that in some exemplary embodiments, the plurality of light sources can include light sources that emit light at a plurality of different wavelengths or wavebands when energized by an electrical current, so that the plurality of light sources emit light in a plurality of different colors. The resulting light emitting display can then be used either for decorative purposes or to enhance the spectra of the light emitted by the display, for a given application.

Another aspect of this novel technology is directed to a method for energizing a plurality of light sources mounted on a light emitting display, so that each of the plurality of light sources emit light of either substantially the same intensity or desired different intensities. The method includes mounting the plurality of light sources to a substrate in a spaced-apart array, so that the plurality of light sources are energized by an electrical current supplied by a power bus on the substrate. In this configuration, a voltage drop occurs along the power bus, causing a decreasing voltage to be supplied by the power bus to successive light sources connected to the power bus, as a distance from an end of the power bus connected to a power source increases. There is a maximum number of light sources that can be included in an array and still achieve equal current through each, for a given cross section of the power bus and applied voltage. Extending the length of the light emitting display to the maximum minimizes the amount of material used to form the power bus for a given power bus cross section and applied voltage, for a constant width for the conductors used for the power bus.

Resistive traces are formed on the substrate to electrically connect each of the plurality of light sources with the power bus and convey the electrical current between the power bus and the plurality of light sources. When the resistive traces are formed on the substrate, a characteristic of the resistive traces is selectively controlled to at least in part compensate for the voltage drop that occurs along the power bus. Specifically, the characteristic of the resistive traces is selectively controlled to vary the resistance of the resistive traces to an electrical current, so that a desired electrical current flows through each of the plurality of light sources, and so that he plurality of light source emit light of either substantially the same intensity or desired different intensities. Other details of the method are generally consistent with the discussion of the light emitting display provided above.

This Summary has been provided to introduce a few concepts in a simplified form that are further described in detail below in the Description. However, this Summary is not intended to identify key or essential features of the claimed subject matter, nor is it intended to be used as an aid in determining the scope of the claimed subject matter.

### DRAWINGS

Various aspects and attendant advantages of one or more exemplary embodiments and modifications thereto will become more readily appreciated as the same becomes better understood by reference to the following detailed description, when taken in conjunction with the accompanying drawings, wherein:

FIG. 1 is a schematic plan view of a longitudinally extending array of LEDs that emit light of red, blue, or green color, mounted on an elongate flexible substrate, and provided with resistive traces having a width that is selectively controlled when applied to the substrate so that a desired electrical current flows through the light sources mounted at different points along the length of the flexible substrate;

FIG. 2 is an enlarged plan view of two LEDs and their conductive traces that are mounted at substantially different dispositions along the flexible substrate, illustrating clearly how the resistive traces for the LED that is on the left, which is disposed near the end of the flexible substrate where a direct current (DC) source is applied, are substantially narrower in width than the resistive traces providing current to the other LED;

FIG. 3 is an enlarged plan view of a portion of a flexible substrate and two adjacent LEDs mounted thereon, showing an alternative approach for substantially equalizing the electrical current supplied to each of the LEDs mounted on a flexible substrate by using conductive inks of different conductivity for the conductive traces, to control the current supplied to successive light sources on the flexible substrate;

FIG. 4 is an enlarged schematic plan view of a portion of flexible substrate and two adjacent LEDs mounted thereon, showing yet another alternative approach for substantially equalizing the electrical current supplied to each of the LEDs mounted on a flexible substrate by using both of the approaches shown in FIGS. 1 and 3, i.e., selectively varying the conductivity of the ink applied to produce the conductive traces and also varying the width or other cross-sectional dimension of the conductive traces, such as thickness;

FIG. 5 is a schematic plan view (showing only a portion of the light sources and conductive traces) for a configuration of a flexible substrate that is formed into a letter “P” to show how the present approach can be used for a variety of shapes of elongate flexible substrates to substantially equalize the electrical current provided to each of the LEDs at different mounting positions along the flexible substrate;

FIG. 6 is a schematic isometric view of a positive displacement plotter print head being used to apply traces comprising resistive ink that extend between a power bus and LEDs mounted on the flexible substrate, wherein a computer controls the positive displacement plotter print head to control one or more of the width, thickness, and number of layers of the resistive traces and to use a resistive ink of a specific resistivity, to form the resistive traces, so that substantially equal current (or a desired current) flows through the LEDs mounted at different points along the flexible substrate;

FIG. 7 is a schematic plan view of two resistive traces, illustrating how the positive displacement plotter has applied more strips of resistive ink to form a conductive trace having a higher conductivity compared to another resistive trace having a lower conductivity; and

FIG. 8 is a flow chart illustrating exemplary logic for fabricating a light emitting display as described herein.

### DESCRIPTION

### Figures and Disclosed Embodiments are not Limiting

Exemplary embodiments are illustrated in referenced Figures of the drawings. It is intended that the embodiments and Figures disclosed herein are to be considered illustrative rather than restrictive. No limitation on the scope of the technology and of the claims that follow is to be imputed to the examples shown in the drawings and discussed herein. Further, it should be understood that any feature of one embodiment disclosed herein can be combined with one or more features of any other embodiment that is disclosed, unless otherwise indicated.

### Exemplary Linear Display

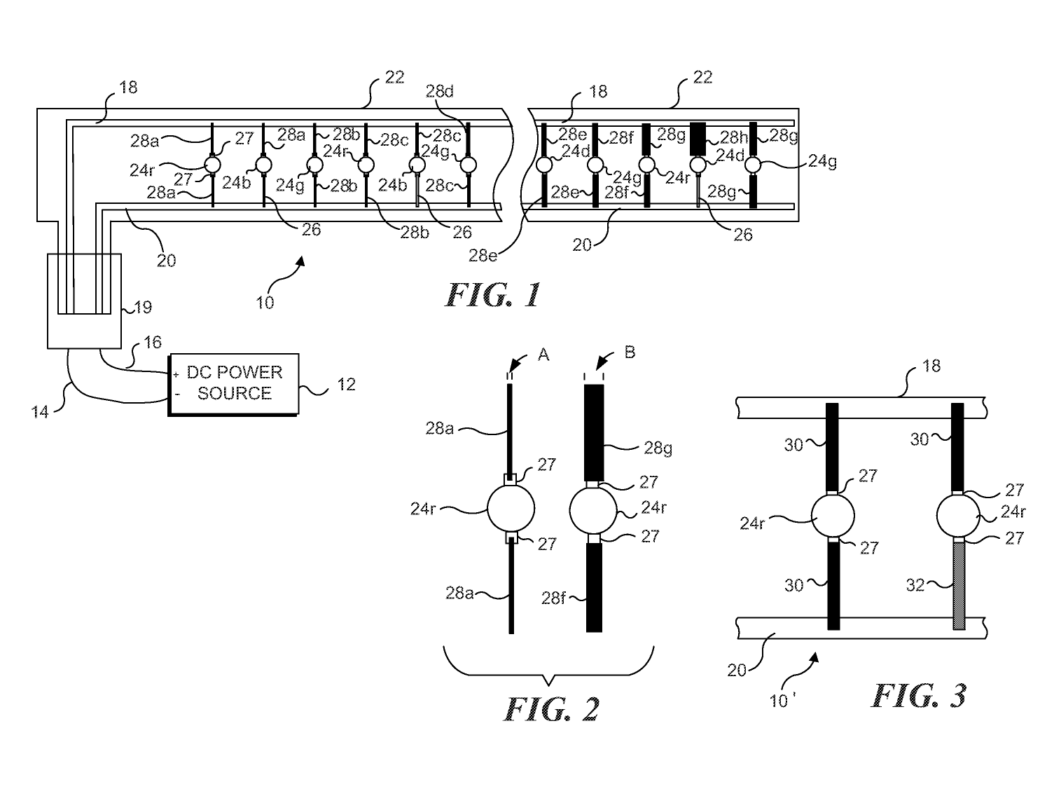

FIG. 1 illustrates an exemplary light emitting display 10 that includes the present approach to ensure that the intensity of light emitted by each of a plurality of three different color LEDs that are included in the display is substantially the same (or is a desired level) and does not decrease as a result of the voltage losses along the length of a power bus used to provide an electrical current to energize the LEDs. In this exemplary light display, red emitting LEDs 24r, blue emitting LEDs 24b, and green light emitting LEDs 24b are mounted to create a repeating sequence of those colors along the length of the light emitting display. Again, it must be emphasized that the present approach is not limited to LEDs, or light sources that emit light with any particular sequence of colors, since many other types of light sources can alternatively be used in a light emitting display that uses the present novel approach to control the electrical current supplied to each light source, so as to achieve substantially uniform or different desired intensities of light emitted by the light sources.

Light emitting display 10 is connected to a generally conventional direct current (DC) power source 12 that provides an electrical current to energize LEDs 24r, 24b, and 24g. DC power source 12 can comprise one or more batteries or a DC power supply that is connected to an alternating current (AC) line source. Conductive leads 14 and 16 convey electrical current from DC power source 12 to a connector 19, which is electrically coupled with the proximal ends of a first bus conductor 18 and a second bus conductor 20. It is also contemplated the DC power source 12 can optionally be coupled to both ends of the first and second bus conductors (not shown). The first and second bus conductors comprise a power bus extending generally along opposite edges of a relatively thin flexible substrate 22 (configured like a flexible tape) and serve as electrical rails formed by applying a conductive ink to the substrate using a positive displacement ink plotter (as described below) or other mechanism suitable for application of the conductive ink to the flexible substrate. The LEDs are of the surface mount type, so that they are bonded to substrate 22 using a suitable adhesive and are connected to first and second bus conductors 18 and 20 with a conductive adhesive to form a parallel network. In this parallel network, the LEDs are spaced apart from each other, like the rungs of a ladder.

In exemplary light emitting display 10, the conductive ink that is used to form first and second bus conductors 18 and 20 includes silver, although other conductive inks can alternatively be used. Although silver is a good electrical conductor, first and second bus conductors 18 and 20 have a finite resistance, so that they exhibit a voltage drop between their proximal and distal ends (or between both ends to which DC power source 12 is connected and a middle portion of the power bus—if that alternative connection scheme is used). Thus, near the point where DC power source 12 is connected by conductive leads 14 and 16 to the proximal ends of first and second bus conductors 18 and 20, the voltage between the bus conductors is greater than at portions of the first and second bus conductors that are more remote from the connection to the DC power source. This voltage drop is conventionally referred to as “an I²R voltage drop,” where I is the current flowing through the first and second bus conductors and R is their resistance. The significance of this voltage drop is its potential impact on the current flowing through the plurality of LEDs that are mounted on flexible substrate 22. The LEDs are configured in a spaced-apart array that extends longitudinally along a length of the thin flexible substrate in this exemplary embodiment. As the voltage between first and second bus conductors 18 and 20 decreases with each successive LED drawing current from the first and second bus conductors, there would normally be a concomitant decrease in the magnitude of electrical current flowing through successive LEDs as the connection points are increasingly farther from the ends of the first and second bus conductors that are connected to the DC power source. Also, because the current flowing in the first and second bus conductors decreases after each successive LED in the parallel connected array of LEDs, the decrease in the voltage along the power bus, moving distally away from the end connected to the DC power source, is not linear.

The decreasing electrical current flowing through the successive light sources would normally decrease the intensity of light that the LEDs disposed farther from the ends of first and second bus conductors 18 and 20 connected to the DC power source emit, compared to the intensity of the light emitted by the LEDs disposed nearer to the DC power source. However, by using the present novel approach, this problem is avoided on light emitting display 10, so that the intensity of the light emitted by all of the plurality of LEDs is substantially the same. Alternatively, the current flowing through different light sources may be controlled using the present novel approach, to achieve different desired intensities of light emission from the plurality of LEDs, e.g., to produce more intense red light emitted by LEDs 24r than the blue and green light respectively emitted by LEDs 24b and 24g.

Resistors are conventionally connected in series with LEDs to limit the current to specified levels. In light emitting display 10, conventional resistors are not used. The only components standing off the surface of the substrate are the LEDs. Instead of conventional resistors, light emitting display 10 uses resistive traces that are printed on the surface of substrate 22 using a positive displacement ink plotter, as discussed in greater detail below. The resistive traces couple the LEDs to the first and second bus conductors. Depending upon the desired resistance, a conductive trace 26 formed of the same type of conductive ink applied to substrate 22 to form first and second bus conductors 18 and 20 may be used instead of a resistive trace to connect between an LED and one of first and second bus conductors 18 and 20. Thus, either one or two resistive traces are used to connect each of the LEDs to the first and second bus conductors. The resistive traces are formed with a resistive ink that includes carbon, although other types of resistive ink may alternatively be used.

In this first exemplary embodiment, the resistance of each of the resistive traces that connect successive LEDs to the first and/or second bus conductors is selectively varied by adjusting the width of the resistive traces to compensate for the voltage drop that occurs along the length of first and second bus conductors 18 and 20. Thus, resistive traces 28a connect a first of the LEDs, which is a red light emitting LED 24r. The LED is closest to the proximal end of first and second bus conductors 18 and 20, i.e., the end that is connected to DC power source 12. The width of conductive traces 28a is relatively narrow and is chosen to have a resistance sufficient to provide a desired electrical current flow through the first red light emitting LED, but must be of a sufficient area for its resistance, so that the watt loading limit of the substrate is not exceeded, as explained below.

For the next or second LED, which is a blue light emitting LED 24b, conductive trace 28a is again used for one leg to connect one pad 27 of LED 24b with first bus conductor 18, but a conductive trace 26 is used for the other leg to connect pad 27 on the other side of the blue light emitting LED with second bus conductor 20. Resistive trace 28a has a substantially greater resistance than conductive trace 26. Since resistive trace 28a, blue light emitting LED 24b, and conductive trace 26 are in a series-connected relationship, it will be apparent that the combined resistance of this combination is less than the combined resistance of two conductive traces 28a and red light emitting LED 24r. The width of conductive trace 28a for the second LED mounted along the substrate is chosen so that the lower resistance of the series combination of conductive trace 26, resistive trace 28a, and blue light emitting LED 24b enables the current flowing through the second LED to be substantially the same as the current flowing through the first LED, thereby compensating for the slight drop in the voltage of the power bus where resistive trace 28a and conductive trace 26 connect the second LED to the first and second bus conductors, compared to where the first LED is connected.

Similarly, a third LED, i.e., a green light emitting LED 24g that is next closest to the DC power source connection, is connected to first and second bus conductors 18 and 20 with two conductive traces 28b, which have a lower resistance than the combination of resistive trace 28a, and conductive trace 26. A fourth, which is another red light emitting LED 24r, is also connected to first and second bus conductors 18 and 20 with a resistive traces 28b and a resistive trace 28c. It should be noted that because different color LEDs can have different forward voltages (i.e., the required voltage to “turn-on” the LED), a different magnitude of resistance may be required for different colored LEDs so that the they emit light with substantially the same intensity. When red, blue, and green light emitting LEDs of substantially the same intensity are disposed sufficiently close to each other on the light emitting display, the human eye will perceive that the location on the display is emitting white light.

This same approach is used for the rest of the resistive traces 28d, 28e, 28f, 28g, and 28h, on light display 10, where each successive resistive trace in this sequence is slightly wider and therefore, has less resistance than the preceding resistive trace in the sequence. The relatively narrower width (A) of resistive traces 28a, which are used to carry electrical current to first red light emitting LED 24r, compared to the substantially much wider width (B) of conductive traces 28g used to carry electrical current to the last red light emitting LED near the distal end of light display 10 (i.e., the third to the last LED), is readily apparent in FIG. 2. Because of the compensation for the voltage drop along the power bus supplying current to these two red light emitting LEDs, they are provided substantially the same electrical current and emit red light with substantially the same intensity. It should be understood that as used herein, a statement that the electrical current flowing through two or more light sources is “substantially the same” is intended to mean that for LEDs of the same type, any differences in the magnitude of the electrical current flowing through the LEDs is insufficient to produce a visually noticeable difference in the intensity of the light emitted by the LEDs when perceived by the human eye.

FIG. 3 illustrates a second exemplary embodiment comprising a light emitting display 10′ in which the conductivity of the resistive ink used to form the conductive traces is varied to control the resistance of the resistance traces carrying electrical current to successive LEDs coupled to first and second bus conductors 18 and 20. In this Figure, substrate 22 is not shown. In the embodiment of FIG. 3, two resistive traces 30 are coupled between first and second bus conductors 18 and 20, and a red light emitting LED 24r. Another red light emitting LED 24r is connected to first and second bus conductors 18 and 20 through a resistive trace 30 and a resistive trace 32, which are of about the same width and thickness. However, resistive trace 32 is formed of a resistive ink that has a slightly higher conductivity than the resistive ink used to form resistive traces 30, and the conductivity of each such resistive ink is carefully selected and controlled. Accordingly, even though a voltage drop occurs along bus conductors 18 and 20 between the points where these two red light emitting LEDs 24r are connected thereto, the lower resistance of resistive trace 32 relative to resistive trace 30 is selected to ensure that substantially the same electrical current flows through the second LED as flows through the first LED, and the intensity of the light that each LED emits visually appears the same. It will be apparent that the conductivity of the resistive ink used to form the resistive traces for connecting each successive LED mounted on the substrate between the opposite ends of the bus conductors can be similarly selectively controlled to ensure that substantially the same electrical current (or a desired electrical current) flows through the light sources, regardless of the distance from the proximal end where each light source is coupled to the first and second bus conductors. As a result, the light sources all emit light of substantially the same intensity (or a desired intensity). However, it is acknowledged that the complexity of printing resistive traces using resistive inks formulated to have more than a few different conductivities is undesirable.

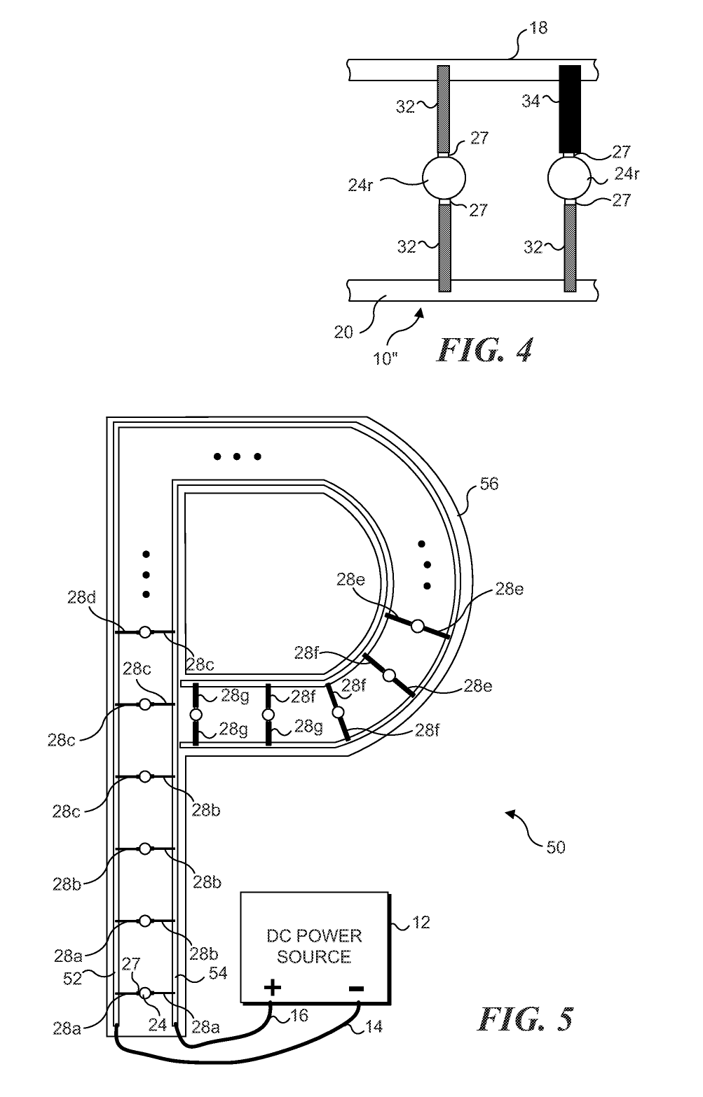

Accordingly, in FIG. 4, an exemplary light emitting display 10″ is schematically illustrated that employs another approach to achieve substantially the same (or a desired magnitude) of electrical current through each of a plurality of LEDs mounted on a substrate. For this embodiment, a combination of the approaches used in the embodiments of light emitting displays 10 and 10′ is used. For this exemplary embodiment, a first red light emitting LED 24r is connected to first bus conductors 18 and 20 through resistive traces 32, while a second red light emitting LED 24r is connected to first and second bus conductors 18 and 20 through one leg comprising a resistive trace 32 and a second leg comprising resistive trace 34. Resistive trace 34 is both wider than resistive traces 32 and formed of a resistive ink that has a higher conductivity than the resistive ink used to form resistive traces 32. Accordingly, the current flowing to successive LEDs between along first and second bus conductors 18 and 20 is controlled to be substantially the same by a combination of selectively adjusting the width and the conductivity of the resistive ink used to apply the resistive traces to the substrate. The benefit of this approach is that resistive inks with fewer different conductivities and only a few different widths of resistive traces are required to achieve the desired substantially equal electrical current supplied to each of the plurality of LEDs used in a light emitting display.

It should also be understood that the thickness (which is a different cross-sectional size than the width) of the resistive ink layer used to form different resistive traces on a substrate can also be selectively controlled to vary the resistance of the conductive traces to achieve a desired current flow through each of the plurality of light sources mounted on the substrate. The thickness, and the conductivity of the resistive ink used to form the conductive traces can also both be selectively controlled to achieve the desired electrical current flowing through each of the light sources. Also, more layers of resistive ink can be applied to the substrate to control the resistance of the resistive traces to achieve a desired magnitude of electrical current flow through successive LEDs mounted on a substrate.

Further, yet another variable can be employed to control the electrical current through each LED mounted on the light emitting display. The first and second bus conductors 18 and 20 need not extend in a parallel relationship. Instead, they can become increasing closer together as the distance from the end of the power bus connected to the DC power source increases. As a result, a length of the resistive traces connecting each successive LED to the first and second bus conductors will decrease as the distance from where the power bus is connected to the DC power source increases. The resistance of the resistive traces is directly proportional to their length, so that as they become shorter, their decreasing length (and resultant decreasing resistance) tends to compensate for the decreasing voltage along the power bus, enabling the desired current to be achieved without necessarily varying the width of the resistive traces. However, it may be desirable to also vary the width of the resistive traces as well as using their shorter length to achieve the desired electrical current through the successive LEDs. Also, it may be desirable to control the thickness as well as using the varying length of the resistive traces to achieve a desired magnitude of electrical current flow through each LED, and/or to vary the conductivity of the resistive ink used for the resistive traces. Thus, any one of the variables discussed herein, or any combination of these variables affecting the resistance of the resistive traces, including the width of the resistive traces, their cross sectional size (e.g., thickness), the length of the resistive traces, and the conductivity of the resistive ink used for the resistive traces, may be varied to achieve the desired electrical current flow through each LED mounted on the light emitting display.

Although many light emitting displays will be configured in a longitudinally extending linear array of LEDs, it is also clear that the present approach for equalizing the intensity (or achieving a desired specific intensity of light) from each of a plurality of LEDs in an array is not limited to a linear array of the LEDs. The plurality of LEDs may be configured in a curved array or in some desired shape. For example, an exemplary light emitting display 50 shown in FIG. 5 illustrates an array of LEDs 24 (which emit white light) that are arranged to visually represent the letter “P.” In this embodiment, a first bus conductor 52 and a second bus conductor 54 are configured in the shape of the letter “P,” as is a substrate 56 to which the first and second bus conductors are attached. However, the substrate need not be configured in the same shape as the first and second bus conductors, and might, for example be almost any shape, such as square, rectangular, round, etc. Furthermore, multiple light emitting displays can be configured on the same substrate. The proximal ends of first bus conductor 52 and second bus conductor 54 are coupled to DC power source 12 through leads 14 and 16, respectively. LEDs 24 are connected to first and second bus conductors 52 and 54 through selected pairs of resistive traces 28a, 28b, 28c, 28d, 28e, 28f, and 28g, and may include one leg of a conductive trace 26 (not shown in this Figure) so as to achieve a substantially equal flow of current through successive LEDs 24 (or to enable a desired current flow to achieve some other desired intensity of light emitted from specific ones of the LEDs), as described above. When all of the LEDs on substrate 56 are energized and emit light, the visual appearance of light emitting display 50 is a letter P. Clearly, many other shapes having curves and straight portions can be achieved, to form other alphanumeric characters or other desired shapes and configurations visually represented by LEDs 24. Multiple arrays of separately energized LEDs can be employed to form a more complex light emitting display panel with a plurality of different shapes, and the arrays can be selectively energized in some designated sequence or independently, at different times, or made to flash, or pulsate as desired, by appropriately controlling the electrical current supplied to the LEDs on the display.

### Exemplary Methods for Producing Light Emitting Displays

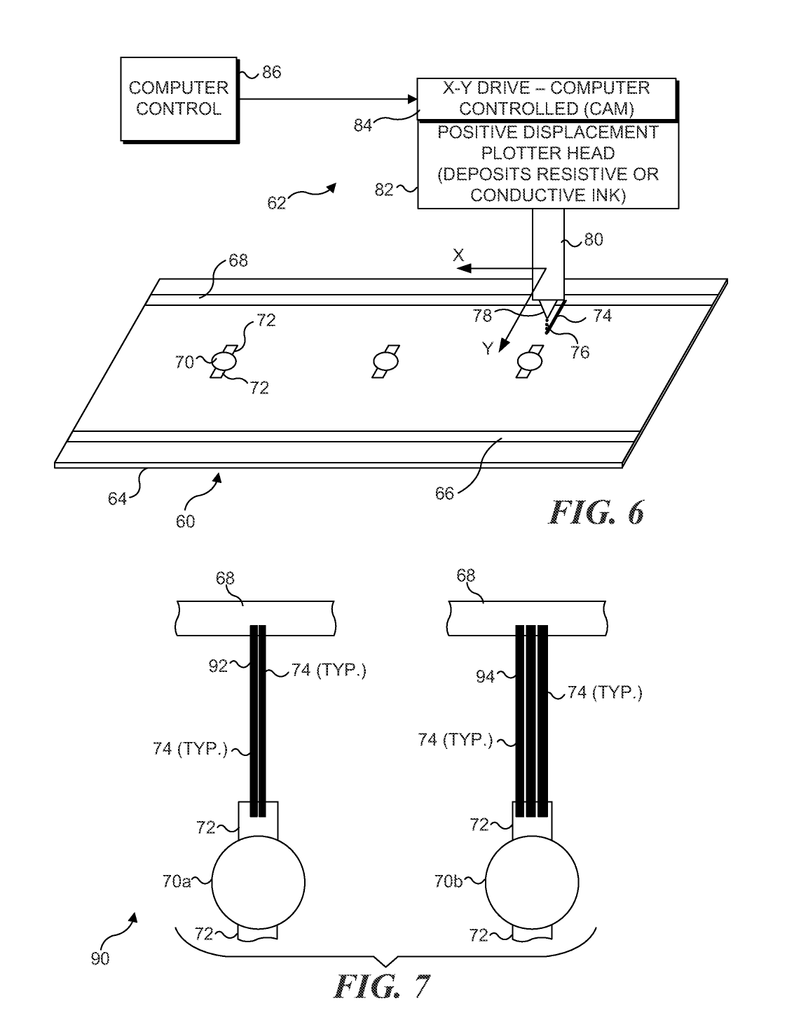

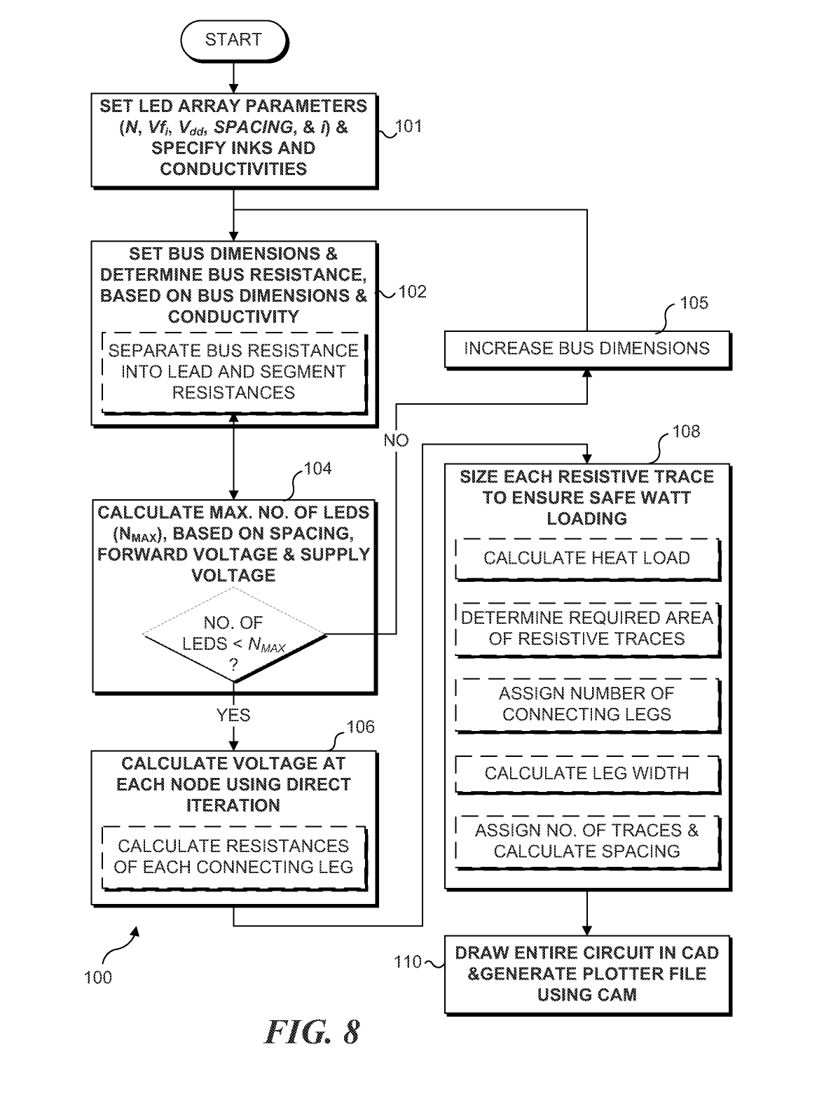

FIG. 6 illustrates an exemplary light emitting display being fabricated on a substrate 64. A plurality of LEDs 70 are surface mounted with an adhesive on the upper surface of substrate 64 in a spaced-apart array that extends longitudinally along the substrate, with conductive tabs 72 extending laterally from opposite sides of each LED 70 toward a first bus conductor 66 that extends adjacent to one edge of substrate 64 and a second bus conductor 68 that extends adjacent to an opposite edge of the substrate. The present method provides for determining the change in voltage along first and second bus conductors 66 and 68 where each successive LED is to be connected, to compensate for the voltage drop that occurs because of the inherent resistance of the first and second bus conductors. By calculating the voltage along the power bus at each point where a LED is connected to the first and second bus conductors, and other parameters, such as the forward voltage required for each type of LED mounted on the substrate, a computer software program calculates the resistance required for the resistive traces that connect each light source to the first and second bus conductors. Details of the logic employed for this calculation are discussed below in connect with a FIG. 8.

The software program determines the desired resistance for the resistive traces used at each LED based on the criteria specified for the LEDs and the locations of the LEDs at each spaced-apart connection location along the power bus. A computer control 86 then controls a positive displacement plotter print head 82 to achieve the desired resistance of the conductive traces. Positive displacement plotter head 82 is moved along at least two orthogonal axes (a third Z axis may also be employed) by an X-Y drive that is controlled by computer control 86 so that it deposits resistive or conductive inks having different conductivity characteristics through a delivery tube 80 and a nozzle 78 to form a stream 76 that impacts the substrate and produces each of a selected number of strips 74 of the resistive ink at a specified spacing, and using resistive ink of a specified conductivity. The plotter head can also print conductive strips and is used to produce first and second bus conductors 66 and 68 by printing strips of conductive ink next to the edges of substrate 64. The number of strips 74 (and/or their thickness or cross-sectional size, or the number of layers of the strips) used to form each resistive trace is selected to achieve the desired resistance for the resistive trace being formed on substrate 64, for a resistive ink of a specified conductivity.

A further consideration when selectively determining the resistance of the conductive traces used at each light source is the watt loading (power per unit area) imposed by current flowing to LEDs through the resistive traces. It is important to ensure that the total watt loading per area of the resistive traces is less than a predefined maximum value for substrate used in the light emitting display, to avoid overheating that might damage the substrate or other portions of the light emitting display. Polyester substrates in particular can be damaged by the heat produced using a very narrow resistive trace that is used near the end of the power bus connected to the DC power source, since the voltage there is relatively high and the required resistance of the resistive trace dictates a resistive trace having a relatively small area. Each specific design for a light emitting display will have its own predefined maximum value for watt loading, depending on the materials used in the substrate for fabricating the display, and other variables.

For a resistive trace that is nearer the end of the first and second bus conductors connected to the DC power source, and for a given conductivity of resistive ink used to form the conductive traces, fewer strips 74 will typically be applied to form the resistive trace, since the desired resistance of such a resistive trace will be greater than for resistive traces that are farther from the proximal end of the power bus. However, as indicated above, different light sources, e.g., different color LEDs, may have different electrical characteristics that alter this general rule, or it may be that emission of different intensity light is desired from specific LEDs. Accordingly, depending on the electrical characteristics of these different light sources, it may be desirable to have lower resistance conductive traces coupled to a specific light source that requires a greater forward voltage, than for ones that requires a lower forward voltage to produce equal (or other desired different) intensities for the respective different color LEDs mounted on the substrate.

FIG. 7 includes a schematic diagram 90 that illustrates the relationship between the width of two resistive traces 92 and 94 that convey electrical current to two different LEDs 70a and 70b disposed at substantially different points along second bus conductor 68. Resistive trace 92 conveys electrical current to LED 70a that is disposed nearer to the end of second bus conductor 68 connected to the DC power source than LED 70b that is supplied current by resistive trace 94. Accordingly, the desired resistance for resistive trace 92 will typically be greater than for resistive trace 94 (barring other considerations such as a desired different intensity of light emission for the two LEDs), since the voltage at second bus conductor 68 where resistive trace 92 is attached is greater than the voltage at the point on the second bus conductor where resistive trace 94 is attached. Thus, assuming that resistive traces 92 and 94 are formed of resistive ink having the same conductivity, in this example, resistive trace 92 is formed by applying only two strips 74 of the resistive ink, while resistive trace 94 is formed by applying three strips 74 of the resistive ink. The larger area (or cross-sectional size) of resistive trace 94 provides it with a greater conductivity than the smaller area (or cross-sectional size) of resistive trace 92, so that compensation is provided for the greater voltage drop on second bus conductor 68 where resistive trace 94 is connected. As a result, substantially the same electrical current flows through LEDs 70a and 70b that are coupled to resistive traces 92 and 94, and the LEDs emit light of about the same intensity.

FIG. 8 illustrates a flowchart 100 showing the logical approach used to determine the desired resistance for each leg of the resistive traces coupled to successive LEDs on a light emitting display, such as those discussed above. First, in a block 101, LED array parameters are set. These parameters include the number of LEDs in the array, N; the forward voltages of the individual LEDs in the array, Vfᵢ; the supply voltage, V_{dd}; the spacing between LEDs, SPACING; and, the current through each LED, i. In a block 102, the power bus dimensions (i.e., width and thickness) are set, and its resistance is determined based on the dimensions and the conductivity of the traces used to produce it. The power bus resistance is separated into the resistance of the leads, e.g., leads 14 and 16, that couple the light emitting display to the DC power source, and the segment resistances, i.e., the resistance of the first and second bus conductors between successive points where the LEDs are to be connected. It should be noted that the segments need not be of equal length if the LEDs are not spaced equal distances apart along the substrate. In this case, the resistance of each different length segment is determined, based on the conductivity of the conductive ink used to form the segments of the first and second bus conductors and their dimensions.

In a block 104, the maximum number of LEDs that can be employed in the light emitting display (Nₘₐₓ) is calculated. The number is based on the spacing (which may be different between different successive LEDs mounted on the substrate), the forward voltage of the LEDs (which may be different for different types of LEDs used in the light emitting display), and the supply voltage provided by the DC voltage source (typically, about 5.0 VDC). In this block, the logic then verifies that the actual number of LEDs to be used on the display is less than Nₘₐₓ. If N is greater than Nₘₐₓ, then the power bus dimensions are increased in a block 105 before returning to block 102.

A block 106 provides for calculating the voltage at each node (each position where an LED is connected to the power bus) using a direct iteration. The supply voltage is determined where a first LED is connected to the power bus. For each segment of the power bus, the resistance of the first and second bus conductors causes the voltage available to provide current to energize the next LED to drop by a specific amount, so that the voltage at each such point is calculated in turn by subtracting the voltage drop from the previous node voltage to determine the voltage at the next node. Using the voltage at each node, the logic then calculates the resistances needed for each connecting leg to provide a desired current to the LED, given the required forward voltage for the LED mounted at that point (and the desired intensity—if not equal for all LEDs).

In a block 108, each resistive trace is sized not only to achieve the desired resistance, but also to ensure a safe watt loading (i.e., heat dissipated per unit surface area per unit time) for the substrate material being used. This process ensures that the power per area of the resistive traces connecting the first and second bus conductors does not exceed a predefined maximum power loading for the substrate material being used. In this procedure, the heat load is determined based on the resistance and the current flow through the resistive traces. The area of the resistive traces is determined to provide the required resistance, but without exceeding the predetermined maximum safe watt loading per area per unit time of the resistive traces. The program then assigns the number of resistive traces that will be used for each LED, i.e., whether two resistive traces will be used, or only one, with a conductive trace being used to connect the other side of the LED to the power bus. The program then calculates the width of the resistive trace(s) that will be used for each LED (or the thickness) or the number of layers, in regard to the conductivity of the resistive ink used (if a plurality of different conductivity resistive inks are employed). For each LED, the program assigns he number of resistive traces and calculates the spacing between strips of the resistive ink that will used for each resistive trace.

Finally, a block 110 provides for drawing the entire circuit for the light emitting display using a computer assisted drawing procedure or program, and then, generating a plotter file to be used to drive the positive displacement plotter head to print the resistive traces on the substrate using a computer aided manufacturing procedure or program. This file is accessed by the computer control when printing the resistive traces on the substrate to produce the light emitting display, as discussed above in connection with FIG. 6.

Although the concepts disclosed herein have been described in connection with the preferred form of practicing them and modifications thereto, those of ordinary skill in the art will understand that many other modifications can be made thereto within the scope of the claims that follow. Accordingly, it is not intended that the scope of these concepts in any way be limited by the above description, but instead be determined entirely by reference to the claims that follow.

The invention in which an exclusive right is claimed is defined by the following:

1. A light emitting display, comprising:
(a) a substrate that includes a power bus having a first bus conductor and a second bus conductor that extend generally from a proximal end of the power bus, the proximal end of the power bus being configured to connect to an electrical power source;
(b) a plurality of light sources that emit light when energized by an electrical current, the plurality of light sources being mounted on the substrate between the first bus conductor and the second bus conductor of the power bus; and
(c) a plurality of resistive traces that extend between the power bus and the plurality of light sources, a resistance of the plurality of resistive traces being selectively controlled at least in part to compensate for a decreasing voltage along the power bus, so that each of the plurality of light sources is energized with a desired electrical current regardless of a distance from the proximal end of the power bus and positions where each of the plurality of light sources is connected to the power bus, causing each of the plurality of light sources to emit light of either substantially the same intensity or desired different intensities.

2. The light emitting display of claim 1, wherein a width of the resistive traces conveying electrical current between the power bus and the light sources is adjusted for successive light sources mounted along the substrate, at different distances from the proximal end of the power bus, the width of the resistive traces being increased to provide a greater conductivity that compensates for a decreasing voltage along the power bus, as the distance from the proximal end increases.

3. The light emitting display of claim 1, wherein a cross-sectional size of the resistive traces conveying electrical current from the power bus to the light sources is adjusted for successive light sources mounted along the substrate, at different distances from the proximal end of the power bus, the cross-sectional size of the resistive traces being increased to compensate for a decreasing voltage along the power bus, as the distance from the proximal end increases.

4. The light emitting display of claim 1, wherein the resistive traces are sized so as to ensure that a predefined power loading for the substrate is not exceeded.

5. The light emitting display of claim 1, further comprising conductive traces that connect the power bus to the plurality of light sources and wherein the conductive traces and the first and second bus conductors are printed on the substrate using a conductive ink that includes silver.

6. The light emitting display of claim 1, wherein the resistive traces comprise a resistive ink that is applied to the substrate.

7. The light emitting display of claim 6, wherein the resistive ink includes carbon.

8. The light emitting display of claim 6, wherein the resistive ink is printed on the substrate using a positive displacement pen plotter.

9. The light emitting display of claim 6, wherein a spacing between the first bus conductor and the second bus conductor becomes increasingly smaller as a distance from where the first bus conductor and the second bus conductor are connected to the electrical power source increases, so that a length of the resistive traces decreases with an increase in said distance, the decreasing length of the resistive traces at least partially compensating for the decreasing voltage along the power bus.

10. The light emitting display of claim 6, wherein a conductivity of the resistive ink is varied to selectively control the resistance of the resistive traces, so that the conductivity of the resistive ink used to apply the resistive traces to the substrate is selectively increased to compensate for a decreasing voltage along the power bus, as the distance from the proximal end increases.

11. The light emitting display of claim 10, wherein at least two variables are selectively varied to achieve the desired electrical current supplied to each of the light sources, the at least two variables being selected from a group of variables consisting of:
(a) a width of the resistive traces;
(b) a cross-sectional size of the resistive traces;
(c) the conductivity of the resistive ink used to form the resistive traces; and
(d) a length of the resistive traces.

12. The light emitting display of claim 1, wherein the plurality of light sources comprises light emitting diodes.

13. The light emitting display of claim 1, wherein the substrate comprises a flexible material that is readily bent without damage to the light emitting display.

14. The light emitting display of claim 1, wherein the substrate is generally elongate in shape.

15. The light emitting display of claim 1, wherein a length of the substrate approaches a theoretical maximum, based on electrical parameters for the light emitting display.

16. The light emitting display of claim 1, wherein the plurality of light sources comprises an array that extends linearly between opposite ends of the power bus.

17. The light emitting display of claim 1, wherein the plurality of light sources comprises an array that defines at least one curve.

18. The light emitting display of claim 1, wherein the plurality of light sources includes light sources that emit light at a plurality of different wavelengths or wavebands when energized by an electrical current, so that the plurality of light sources emit light in a plurality of different colors.

19. The light emitting display of claim 1, wherein the plurality of light sources are disposed on the substrate to visually appear as one or more alphanumeric characters when the plurality of light sources are energized by an electrical current.

20. A method for energizing a plurality of light sources mounted on a light emitting display, so that each of the plurality of light sources emit light of either substantially the same intensity or desired different intensities, comprising:
(a) mounting the plurality of light sources to a substrate in a spaced-apart array, so that the plurality of light sources are energized by an electrical current supplied by a power bus on the substrate, wherein a voltage drop occurs along the power bus, causing a decreasing voltage to be supplied by the power bus to successive light sources connected to the power bus between the proximal and distal ends;
(b) forming resistive traces on the substrate to electrically connect each of the plurality of light sources with the power bus, the resistive traces being provided to convey the electrical current between the power bus and the plurality of light sources; and
(c) when the resistive traces are formed on the substrate, selectively controlling a characteristic of the resistive traces used to convey the electrical current to the plurality of light sources, to at least in part compensate for the voltage drop that occurs between where the power bus is energized and where each of the light sources is connected to the power bus, the characteristic of the resistive traces being selectively controlled to vary the resistance of the resistive traces to an electrical current, so that a desired electrical current flows through each of the plurality of light sources, causing each of the plurality of light sources to emit light of either substantially the same intensity or desired different intensities.

21. The method of claim 20, wherein the characteristic of the resistive traces is controlled by varying a width of the resistive traces applied to the substrate between the proximal end and the distal end of the power bus, so that wider resistive traces are used to connect a light source to the power bus where the voltage on the power bus is lower, an increased conductivity of the wider resistive traces compensating for a reduced voltage on the power bus.

22. The method of claim 20, wherein the characteristic of the resistive traces is controlled by varying a cross-sectional size of the resistive traces applied to the substrate between the proximal end and the distal end of the power bus, so that resistive traces having a greater cross-sectional size are used to connect a light source to the power bus where the voltage on the power bus is lower, an increased conductivity of the resistive traces having a greater cross-sectional size compensating for a reduced voltage on the power bus.

23. The method of claim 20, wherein the resistive traces are formed by printing a resistive ink on the substrate to form each of the resistive traces.

24. The method of claim 23, wherein the resistive traces are formed by printing the resistive ink on the substrate using a positive displacement pen plotter.

25. The method of claim 23, where the characteristic of the resistive traces is controlled by varying a length of the resistive traces, so that increasing shorter resistive traces are employed to at least partially compensate for a reduced voltage along the power bus.

26. The method of claim 23, wherein the characteristic of the resistive traces is controlled by varying a conductivity of the resistive ink used to form the resistive traces, so as to selectively control the resistance of the resistive traces, by using a resistive ink with a greater conductivity to form the resistive traces on the substrate where the voltage on the power bus is lower, to compensate for a reduced voltage along the power bus.

27. The method of claim 26, wherein the characteristic of the resistive traces is controlled by selectively varying at least one variable so that the electrical current supplied to each of the light sources is controlled to compensate for changes in the voltage of the power bus, the at least one variable being selected from a group of variables consisting of:
(a) a width of the resistive traces;
(b) a cross-sectional size of the resistive traces;
(c) the conductivity of the resistive ink used to form the resistive traces; and
(d) a length of the resistive traces.

28. The method of claim 20, wherein mounting the plurality of light sources to the substrate comprises mounting a plurality of light emitting diodes to the substrate.

29. The method of claim 20, further comprising attaching the plurality of light sources to the substrate so as to form an array that extends linearly between opposite ends of the power bus.

30. The method of claim 29, further comprising employing an array that approaches a theoretical maximum length, for the plurality of light sources used to form the light emitting display.

31. The method of claim 20, further comprising attaching the plurality of light sources to the substrate so that the spaced-apart array defines at least one curve.

32. The method of claim 20, further comprising of using light sources that emit light at a plurality of different wavelengths or wavebands for the plurality of light sources, so that the plurality of light sources visually appear to emit light of different colors.

33. The method of claim 20, wherein mounting the plurality of light sources to the substrate comprises mounting the plurality of light sources so that the spaced-apart array visually appears as one or more alphanumeric characters when the plurality of light sources are energized by the electrical current.

34. The method of claim 20, further comprising selectively controlling the characteristic to prevent exceeding a predefined maximum power load for the substrate.

35. The method of claim 20, wherein forming the resistive traces comprises printing the resistive traces using a resistive ink that includes carbon.

36. The method of claim 20, further comprising printing the power bus and one or more other conductive traces on the substrate using a conductive ink that includes silver.

37. The method of claim 20, wherein mounting the plurality of light sources to a substrate comprises affixing the plurality of light sources on a polyester substrate.
